(19) United States
(12) Patent Application Publication
(10) Pub. No.: US 2016/0092707 A1
(43) Pub. Date: Mar. 31, 2016

(54) SYSTEM, DEVICE AND METHOD FOR TRACKING PRAYER

(71) Applicant: UMM AL-QURA UNIVERSITY, Makkah (SA)

(72) Inventors: Amgad Magdy Ahmed MADKOUR, Makkah (SA); Saleh BASALAMAH, Makkah (SA)

(73) Assignee: UMM AL-QURA UNIVERSITY, Makkah (SA)

(21) Appl. No.: 14/391,219

(22) PCT Filed: Sep. 25, 2014
(86) PCT No.: PCT/IB2014/001926

§ 371 Date: Oct. 8, 2014

(51) Int. Cl. G06K 7/10; A44C 23/00; G09B 19/00

(52) U.S. Cl. CPC G06K 7/10366; G09B 19/00; A44C 23/00

(57) ABSTRACT

A beaded prayer system includes a beaded prayer device, which includes a plurality of beads connected by at least one wire that passes through a center of the plurality of beads. The beaded prayer device also includes a power source and processing circuitry that can detect contact between two or more adjacent beads, store bead contact data in memory, and transmit the bead contact data to one of a plurality of RFID readers. The beaded prayer system also includes at least one server that receives the bead contact data from one of the plurality of RFID readers, processes the bead contact data to perform pattern extraction, and outputs usage patterns and/or statistics based on the pattern extraction.

### BACKGROUND

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly nor impliedly admitted as prior art against the present disclosure.

Pilgrims visiting religious sites often carry beaded prayer devices, such as sibhas, to assist them with praying. Many pilgrims visit the religious sites at designated times, which can cause crowdedness at those areas.

### SUMMARY

In an exemplary embodiment, a beaded prayer system includes a beaded prayer device, which includes a plurality of beads connected by at least one wire that passes through a center of the plurality of beads. The beaded prayer device also includes a power source and processing circuitry that can detect contact between two or more adjacent beads, store bead contact data in memory, and transmit the bead contact data to one of a plurality of RFID readers. The beaded prayer system also includes at least one server that receives the bead contact data from one of the plurality of RFID readers, processes the bead contact data to perform pattern extraction, and outputs usage patterns and/or statistics based on the pattern extraction.

The foregoing general description of exemplary implementations and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of a beaded prayer device, according to certain embodiments;

FIG. 2 illustrates an exemplary beaded prayer system, according to certain embodiments;

FIG. 3 is an exemplary flowchart for a bead contact process, according to certain embodiments;

FIG. 4 is an exemplary flowchart for a data transmission process, according to certain embodiments;

FIG. 5 is an exemplary flow chart for a power generation process, according to certain embodiments;

FIG. 6 is an exemplary illustration of a bead contact pattern, according to certain embodiments;

FIG. 7 is an exemplary illustration of an accomplished route pattern, according to certain embodiments;

FIG. 8 is an exemplary illustration of an area congestion determination, according to certain embodiments;

FIG. 9 is an exemplary illustration of a path determination, according to certain embodiments; and

FIG. 10 illustrates a non-limiting example of a pattern extraction device, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

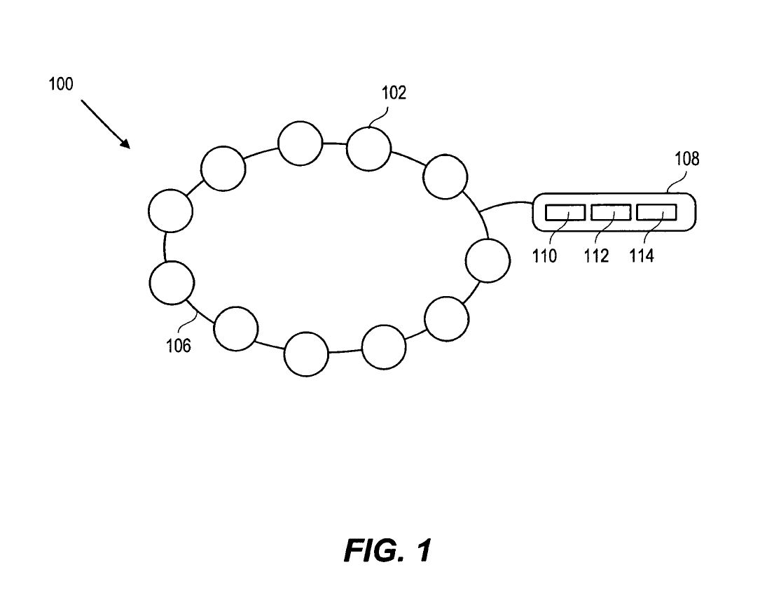

FIG. 1 is an exemplary illustration of a beaded prayer device 100, according to certain embodiments. The beaded prayer device 100 includes a plurality of beads 102 that can be approximately spherical in shape. Examples of a beaded prayer device 100 can include a sibha, a rosary, or the like. A bead 102 can be fabricated from materials such as plastic, metal, stone, marble, or the like. In some embodiments, more than one bead 102 is included in the beaded prayer device 100. As such, the terms referring to the one or more than one bead 102 can be used interchangeably. In certain embodiments, a kinetic-to-electric energy converter can be embedded within each of the beads 102 in the beaded prayer device 100. In some implementations, the beads 102 are made of a piezoelectric material such as quartz, ceramics, and other natural or synthetic materials that generate electric energy based on motion. The beads are connected by at least one wire 106 that passes through a center of each bead that can transmit electric signals. The electric energy that is generated by the kinetic-to-electric energy converters can be transferred via the at least one wire 106 to a power source 112 that is included in an end section 108. Details regarding the kinetic-to-electric energy conversion are discussed further herein.

The at least one wire 106 that passes through the approximate center of each bead can also transmit bead contact data, according to certain embodiments. In some implementations, sensors are embedded within at least one of the plurality of beads 102 that can detect when two or more adjacent beads 102 come in contact with one another. The sensors can include pressure sensors, frequency sensors, or the like. In one embodiment, the sensors are embedded in all of the plurality of beads 102 in the beaded prayer device 100. In some aspects, the bead contact data can include instances of the two or more adjacent beads coming in contact with one another, such as when the beaded prayer device 100 is being used to count a number of prayers. As a user completes a prayer, he or she moves to the next successive bead, which can cause the beads to come in contact with one another. The sensors detect the contact between the beads 102, and the bead contact data is transmitted via the at least one wire 106 to a data acquisition unit 110, which is included in the end section 108. The data acquisition unit 110 can include processing circuitry and a memory that processes and/or stores bead contact data and programs stored thereon to implement processes described herein as could be understood by one of ordinary skill in the art. Details regarding the processing and storing of the bead contact data are discussed further herein.

In addition to the power source 112 and the data acquisition unit 110, the end section 108 can also include a radiofrequency identification (RFID) transmitter 114, according to certain embodiments. In some implementations, the RFID transmitter 114 includes a RFID tag that can uniquely identify one or more beaded prayer devices. Details regarding the transmission of the bead contact data to the RFID reader are discussed further herein.

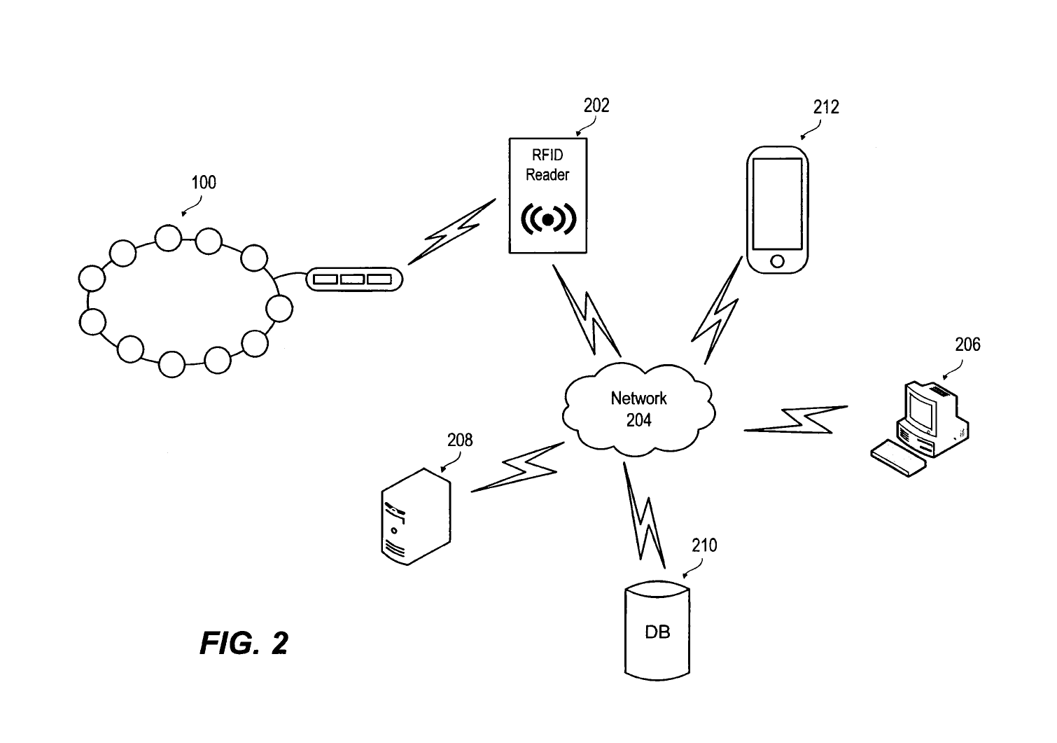

FIG. 2 illustrates an exemplary beaded prayer system, according to certain embodiments. The beaded prayer device 100 is shown connected to a RFID reader 202, which is connected to a server 208, database 210, pattern extraction device 206, and mobile device 212 via a network 204. The pattern extraction device 206 acts as a client device that is connected to a server 208, a database 210, a mobile device 212, and the RFID reader 202 via the network 204. The server 208 represents one or more servers connected to the pattern extraction device 206, the database 210, the mobile device 212, and the RFID reader 202 via the network 204. The pattern extraction device 206 may interchangeably be known as the computer as described further herein. The database 210 represents one or more databases connected to the pattern extraction device 206, the server 208, the mobile device 212, and the RFID reader 202 via the network 204. The mobile device 212 represents one or more mobile devices connected to the pattern extraction device 206, the server 208, the database 210, and the RFID reader 202 via the network 204. The mobile device 212 represents one or more mobile devices connected to the pattern extraction device 206, the server 208, the mobile device 212, and the database 210 via the network 204. The network 204 represents one or more networks, such as the Internet, connecting the pattern extraction device 206, the server 208, the database 210, the mobile device 212, and the RFID reader 202. In some embodiments, more than one RFID reader 202 is included in the beaded prayer system. As such, the terms referring to the one or more than one RFID reader 202 can be used interchangeably.

When the beaded prayer device 100 is within the vicinity of the RFID reader 202, the RFID transmitter 114 can wirelessly transmit the bead contact data from the data acquisition unit 110 to the RFID reader 202. The bead contact data can then be transferred to the server 208, the database 210, and the pattern extraction device 206 via the network 204. The pattern extraction device 206 can include processing circuitry that can perform pattern extraction on the bead contact data to compute usage patterns and/or statistics regarding the beaded prayer device 100. For example, the pattern extraction device 206 can determine a number of prayers performed by a user based on the number of contacts made between successive pairs of beads. The pattern extraction device 206 can also determine a route that has been accomplished by a user, such as a number of times the user has circumambulated a geographic landmark. In addition, in some implementations, the pattern extraction device 206 can also determine congestion of an area covered by a plurality of RFID readers 202. In this example, a direction and velocity of one of more users with a beaded prayer device 100 is determined based on the times of communication between the RFID transmitter 114 on the beaded prayer device 100 and the one or more RFID readers 202. For example, the processing circuitry can determine the velocity of the user based on the times that the RFID transmitter 114 communicates with two or more RFID readers 202 that are a known distance apart. In addition, the direction that the user is traveling can be determined based on the relative direction between the RFID reader 202 that the RFID transmitter 114 has communicated with most recently and the one or more previous RFID readers 202 with which the RFID transmitter 114 has communicated.

In some embodiments, the beaded prayer device 100 can be equipped with circuitry that allows the beaded prayer device 100 to communicate via wireless networks and methods other than or in addition to the RFID transmitter 114 and one or more RFID readers 202. For example, the beaded prayer device 100 can include circuitry to communicate via wireless networks such as WI-FI, BLUETOOTH, cellular networks including EDGE, 3G and 4G wireless cellular systems, or any other wireless form of communication that is known. In certain embodiments, the velocity and direction that the user is travelling can be determined based on the times of communication and locations of wireless network access points, cellular towers, and the like.

In certain embodiments, the processing circuitry in the pattern extraction device 206 can also be configured to compute a suggested route for a user of the beaded prayer device. The results of the pattern extraction can be displayed via an interface at the pattern extraction device 206 and can also be transmitted to a mobile device 212 for display to the user via an application. Details regarding the pattern extraction are discussed further herein.

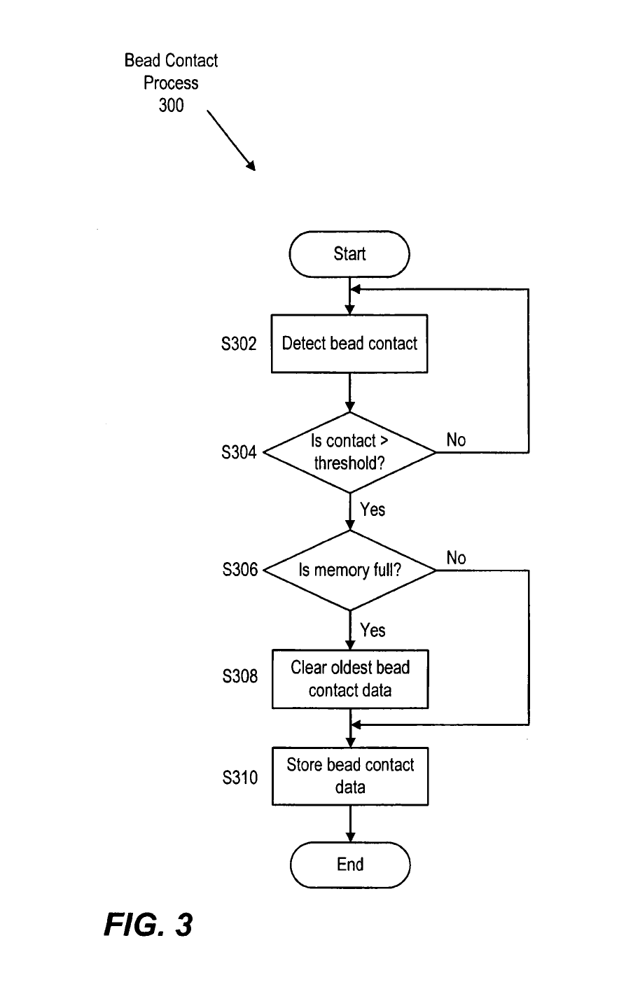

Next, FIG. 3 is an exemplary flowchart for a bead contact process 300, according to certain embodiments. At step S302, the bead contact is detected by processing circuitry in the data acquisition unit 110. In some implementations, one or more sensors are embedded within at least one of the plurality of beads 102 that can detect when two or more adjacent beads 102 come in contact with one another. The sensors can include pressure sensors, frequency sensors, or the like. In one embodiment, the sensors are embedded in each of the plurality of beads 102 in the beaded prayer device 100. In some aspects, the bead contact data can include instances of the two or more adjacent beads coming in contact with one another, such as when the beaded prayer device 100 is being used to count a number of prayers. As a user completes a prayer, he or she moves to the next successive bead, which can cause the beads to come in contact with one another. The sensors detect the contact between the beads 102, and the bead contact data is transmitted via the at least one wire 106 to a data acquisition unit 110, which is included in the end section 108. In certain embodiments, the sensors that are connected to individual beads of the beaded prayer device 100 have identification codes or markers so that the bead contact data can include a sensor value, time of contact, and/or the identification codes of the beads 102 of the beaded prayer device 100 that made contact with one another. In one example where pressure sensors are embedded within the beads, the sensor value of the bead contact data can include a magnitude of pressure sensed by the two or more beads that came in contact with one another. In addition, in an example where frequency sensors are embedded within the beads, the sensor value of the bead contact data can include a frequency of vibration sensed by the beads that made contact with one another.

At step S304, a determination is made of whether the bead contact data provided by the one or more sensors is greater than a predetermined threshold. In certain embodiments, when the two or more of the beads 102 come in contact with one another, the sensors embedded within the one or more beads output the sensor value corresponding to the force of contact between the two or more beads. If the magnitude of the sensor value is greater than the predetermined threshold, resulting in a “yes” at step S304, then step S306 is executed. For example, if pressure sensors are embedded within at least one of the two or more beads that come in contact with one another, the predetermined threshold is set to a minimum pressure magnitude that can represent contact between the beads rather than just general bumps between the beads. Otherwise, if the magnitude of the sensor value is less than or equal to the predetermined threshold, resulting in a “no” at step S304, then the bead contact process 300 is returns to the start of the process, and the bead contact data is not stored in the memory.

In some implementations, step S304 can determine whether the bead contact data provided by the one or more sensors is greater than a lower threshold and less than an upper threshold. In this implementation, if the sensor value corresponding to the force of contact between the two or more beads is greater than the lower threshold but less than the upper threshold, resulting in a “yes” at step S304, then step S306 is executed. For example, if frequency sensors are embedded within at least one of the two or more beads that come in contact with one another, the frequency of the beads making contact with one another may vary depending on a type of material that the beads are made of. In some embodiments, there can be a characteristic frequency range that the beads of the type of material exhibit when making contact with one another. The upper and lower thresholds are set to values that are approximately equal to the characteristic frequency range. If the magnitude of the sensor value is less than or equal the lower threshold or greater than or equal to the upper threshold, resulting in a “no” at step S304, then the bead contact process 300 is returns to the start of the process, and the bead contact data is not stored in the memory.

At step S306, a determination is made of whether the memory in the data acquisition unit 110 is full. In some implementations, the memory of the data acquisition unit 110 can hold a maximum number of items of the bead contact data. If the memory is storing the maximum number of items of the bead contact data, resulting in a “yes” at step S306, then step S308 is executed. Otherwise, if the memory is storing a number of items of the bead contact data that is less than the maximum, resulting in a “no” at step S306, then the bead contact process 300 moves to step S310.

At step S308, if the memory in the data acquisition unit 110 is full, the oldest item of the bead contact data is cleared from the memory. In certain embodiments, the memory of the data acquisition unit 110 stores the bead contact data in a first-in-first-out (FIFO) manner. If the determination is made at step S306 that the memory is full, the oldest item of the bead contact data is cleared from the memory to make room for the newest item of the bead contact data. At step S310, the newest item of the bead contact data is stored in the memory of the data acquisition unit 100. In certain embodiments, the bead contact data that is stored in the memory can include the sensor value, time of contact, and/or the identification codes of the beads 102 of the beaded prayer device 100 that made contact with one another.

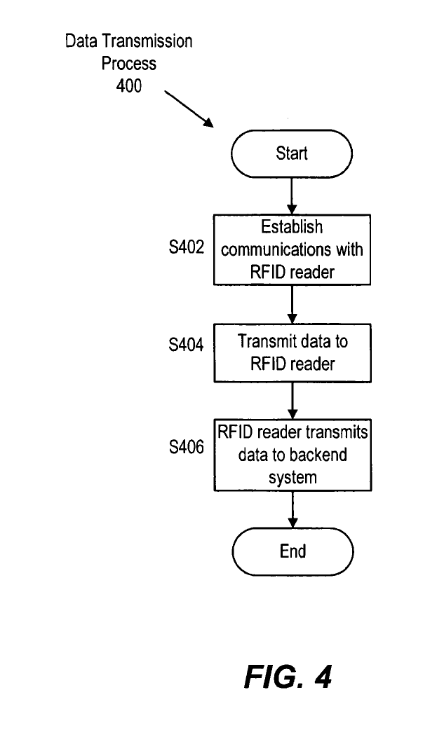

FIG. 4 is an exemplary flowchart for a data transmission process 400, according to certain embodiments. At step S402, the RFID transmitter 114 establishes communication with the RFID reader 202. In certain embodiments, the RFID transmitter 114 and the RFID reader 202 communicate wirelessly at a common frequency. In some implementations, the RFID tag on the RFID transmitter 114 communicates with the RFID reader 202 in the UHF range, which can accommodate data transmission at ranges between approximately 1 m (meter) to 100 m. The distance at which the RFID tag on the RFID transmitter 114 can establish communications with the RFID reader is based on the communication frequency. In one aspect, the RFID tag can actively transmit radio signals in order to establish communications with either an active or passive RFID reader 202. In another aspect, the RFID tag passively can receive interrogations from an active RFID reader 202. Once communication has been established, the RFID reader 202 can determine if the RFID tag is recognized as being associated with a beaded prayer device 100. In certain embodiments, beaded prayer devices have unique RFID tags that allow users to be distinguished from one another. If the RFID tag is recognized, then the data transmission process 400 executes step S404.

At step S404, the RFID transmitter 114 transmits the bead contact data to the RFID reader 202. Once communications have been established between the RFID transmitter 114 and the RFID reader 202, and the RFID reader 202 determines that the RFID tag is associated with a known beaded prayer device 100, then the RFID transmitter 114 can wirelessly transmit the bead contact data stored in the memory of the data acquisition unit 110 to the RFID reader 202. In some embodiments, the bead contact data that is transmitted to the backend server can include the sensor value, time of contact, and/or the identification codes of the beads 102 of the beaded prayer device 100 that made contact with one another. Once the bead contact data has been transmitted to the RFID reader 202, the data acquisition unit 110 clears the stored bead contact data from the memory.

At step S406, the RFID reader 202 transmits the bead contact data to a backend system, which can include the server 208, the database 210, and the pattern extraction device 206. Additional items of data can be added to the bead contact data that indicate which RFID reader 202 received the bead contact data and at what time the bead contact data was transferred from the beaded prayer device 100 to the RFID reader 202. In some embodiments where at least one RFID reader 202 is placed in an area, the pattern extraction device 206 can receive the bead contact data and can compute the route a user has taken and can determine how fast and in what direction the user is traveling based on the times the beaded prayer device 100 communicated with the at least one RFID reader 202.

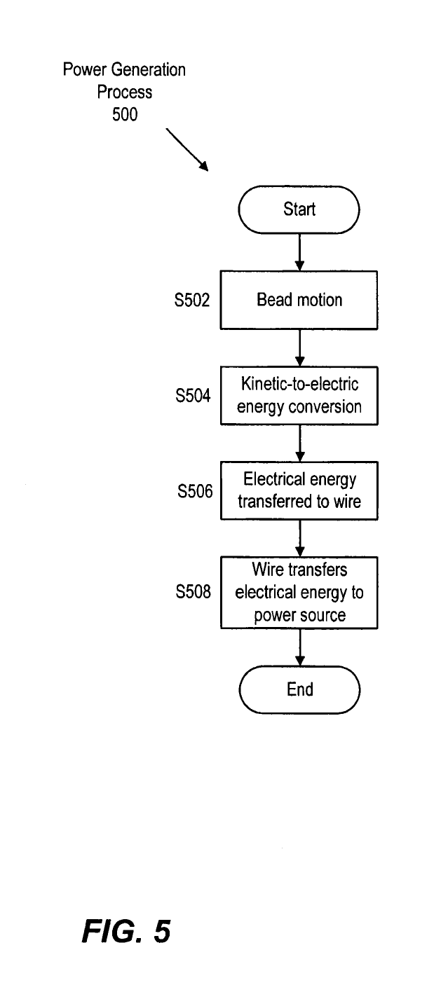

FIG. 5 is an exemplary flow chart for a power generation process 500, according to certain embodiments. At step S502, one or more beads 102 of beaded prayer device 100 undergo motion, which can be a source of kinetic energy. This motion can include a user advancing the beads during prayer. In certain embodiments, the motion of the beads can also include general movement of the beaded prayer device 100 as the user moves a hand in which the beaded prayer device 100 is being held.

At step S504, the kinetic energy generated from the motion of the beads 102 is converted to electric energy. In certain embodiments, a kinetic-to-electric energy converter can be embedded within one or more of the beads 102 of the beaded prayer device 100. The kinetic-to-electric energy converter can include oscillating weights that can rotate as a user moves the beaded prayer device 100, which establishes a magnetic field. As the magnetic field turns past a wire coil, it can stimulate an electric current. In some implementations, the beads 102 are made of a piezoelectric material such as quartz, ceramics, and other natural or synthetic materials that generate electric energy based on motion.

At step S506, the electric energy is transferred to the at least one wire 106. In certain embodiments where the kinetic-to-electric energy converter is embedded within one or more of the beads 102 of the beaded prayer device 100, the at least one wire 106 is electrically connected to the kinetic-to-electric energy converter so that when the electric current is stimulated by the rotating magnetic field, the electric current is then transferred to the at least one wire 106. In some implementations where the beads 102 are made of a piezoelectric material, the at least one wire 106 comes in contact with the beads 102 and receives the electric energy generated by the piezoelectric material.

At step S508, the at least one wire 106 transfers the electric energy to the power source 112 for the beaded prayer device 100. In some implementations the power source 112 for the beaded prayer device 100 can be a capacitor that stores the electric energy that has been generated from the motion of the beaded prayer device 100. In addition, in certain embodiments, the power source 112 can also have a back-up battery such as a watch battery or button cell to provide power to the beaded prayer device 100 if the capacitor fails or becomes depleted of stored electric energy.

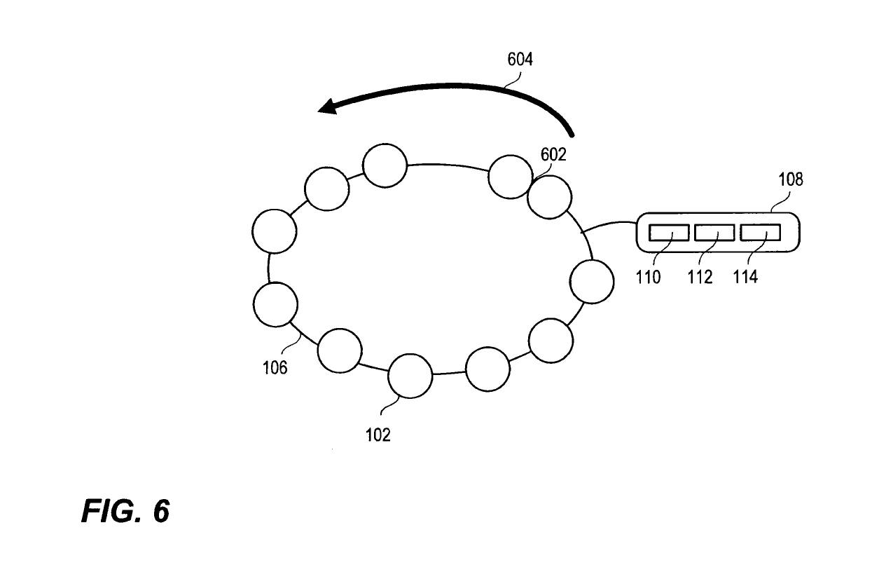

FIG. 6 is an exemplary illustration of a bead contact pattern, according to certain embodiments. A person conducting prayer uses the beaded prayer device 100 to keep track of a number of prayers performed. In one example, a user can be performing Tasbih, which is a set of repetitive prayers said in succession, and the beaded prayer device 100 can assist the user with determining the number of prayers that have been performed. For example, a user can advance the beads 102 in direction 604 as the prayers are completed. As the user advances the beads 102 sequentially around the beaded prayer device 100, bead contact 602 can result that corresponds to the number of prayers completed. The one or more sensors embedded within the beads 102 and processing circuitry in the data acquisition unit 110 can detect the bead contact 602, as previously discussed. Each instance of the bead contact 602 between two or more adjacent beads 102 can be part of the bead contact data, which can include sensor value, time of contact, and/or the identification codes of the beads 102 of the beaded prayer device 100 that made contact with one another.

The bead contact data can be transmitted from the RFID transmitter 114 to the RFID reader 202, which then sends the bead contact data via the network 204 to the backend system, which can include the server 208, database 210, and pattern extraction device 206. The processing circuitry in the pattern extraction device 206 can determine from the bead contact data how many of the prayers have been said in succession, which can correspond to a number of times of completing Tasbih. In certain embodiments, the pattern extraction device 206 can also output at what time Tasbih was performed and the location of the user when Tasbih was performed. The number of prayers performed as well as the time and location while completing the prayers can be output to a mobile device 212 to be viewed by the user.

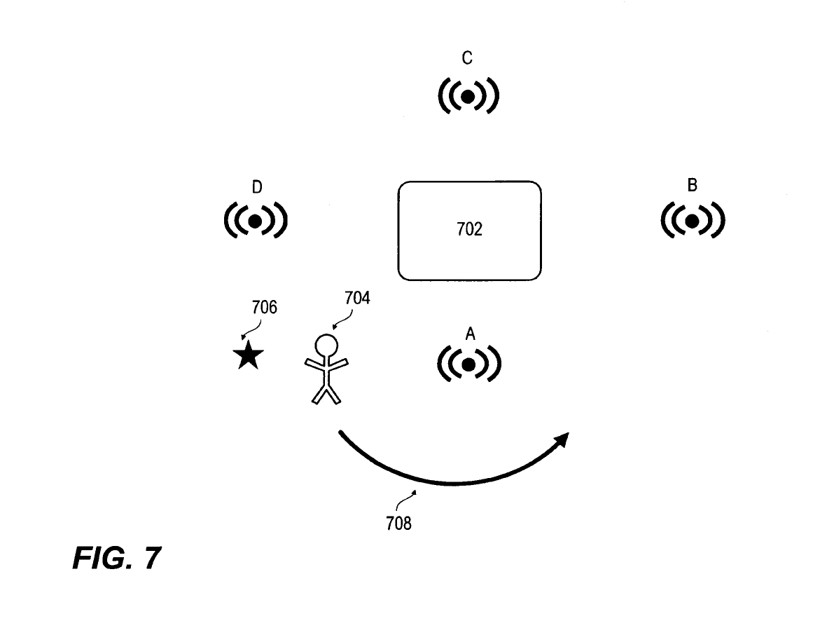

FIG. 7 is an exemplary illustration of an accomplished route pattern, according to certain embodiments. In certain embodiments, the user of the beaded prayer device 100 can be transiting through an area that has at least one RFID reader 202. If the user travels within the communication range of the at least one RFID reader 202, the bead contact data is transmitted to the RFID reader 202. The bead contact data that is transmitted to the backend server can include the sensor value, time of contact, and/or the identification codes of the beads 102 of the beaded prayer device 100 that made contact with one another. In some embodiments, the pattern extraction device 206 can determine a path that the user has taken based on which of the at least one RFID reader 202 that the beaded prayer device 100 has communicated with and the times of communication with the at least one RFID reader 202.

In one example, a pilgrim 704 who is using the beaded prayer device 100 is performing Tawaf of Kaaba, which is a circumambulation of sacred site Kaaba seven times in succession while reciting prayers. In the example, RFID readers A, B, C, and D are located in a path that pilgrims travel while performing the Tawaf of Kaaba. In some embodiments, a larger or smaller number of the RFID readers may be used. In one implementation, the pilgrim 704 can begin at starting point 706 and travel in counter-clockwise direction 708 around structure 702, which can represent Kaaba in the example. As the pilgrim 704 circumambulates the structure 702, the RFID transmitter 114 communicates with the RFID readers A, B, C, and D to transmit the bead contact data when the beaded prayer device 100 that the pilgrim 704 possesses comes within the communication range of the RFID readers A, B, C, and D. The pattern extraction device 206 can use the locations of the RFID readers A, B, C, and D as well as times at which the beaded prayer device 100 that the pilgrim 704 possesses communicates with the RFID readers A, B, C and D to determine how many times and how fast the pilgrim 704 has circumambulated the structure 702.

The pattern extraction device 206 can determine the velocity of the user based on the times that the RFID transmitter 114 communicates with two or more RFID readers 202 that are a known distance apart. For example, in certain embodiments, RFID reader A and RFID reader B are 1 kilometer (km) apart. If the RFID transmitter 114 on the beaded prayer device 100 that the pilgrim 704 is using communicates with RFID reader A at 12:00 PM and then communicates with RFID reader B at 12:20 PM, it can be determined that the pilgrim 704 is travelling at approximately 3 km/hour.

In addition, the direction that the user is traveling can be determined based on the relative direction between the RFID reader 202 that the RFID transmitter 114 has communicated with most recently and the one or more previous RFID readers 202 with which the RFID transmitter 114 has communicated. For example, in certain embodiments, RFID reader B can be located at a position that is northeast of RFID reader A. If the RFID transmitter 114 on the beaded prayer device 100 that the pilgrim 704 is using has most recently communicated with RFID reader B and has previously communicated with RFID reader A, it can be determined that the pilgrim 704 has traveled in a northeastern direction. If the RFID transmitter 114 communicates with RFID reader C after communication with RFID reader B, it can be determined that the pilgrim may be travelling in a counter-clockwise direction around the structure 702.

Information pertaining to the route of the pilgrim 704, which can include the number of times the pilgrim has circumambulated the structure 702 can be output to a mobile device 212 to be viewed by the pilgrim. In some embodiments, the pilgrim 704 can receive audio and/or visual alerts pertaining to the route via the mobile device 212. In another embodiment, a receiver for a positioning system, such as GPS, can be installed in the end section 108 of the beaded prayer device 100 that can be used to determine the route that the pilgrim 704 has taken.

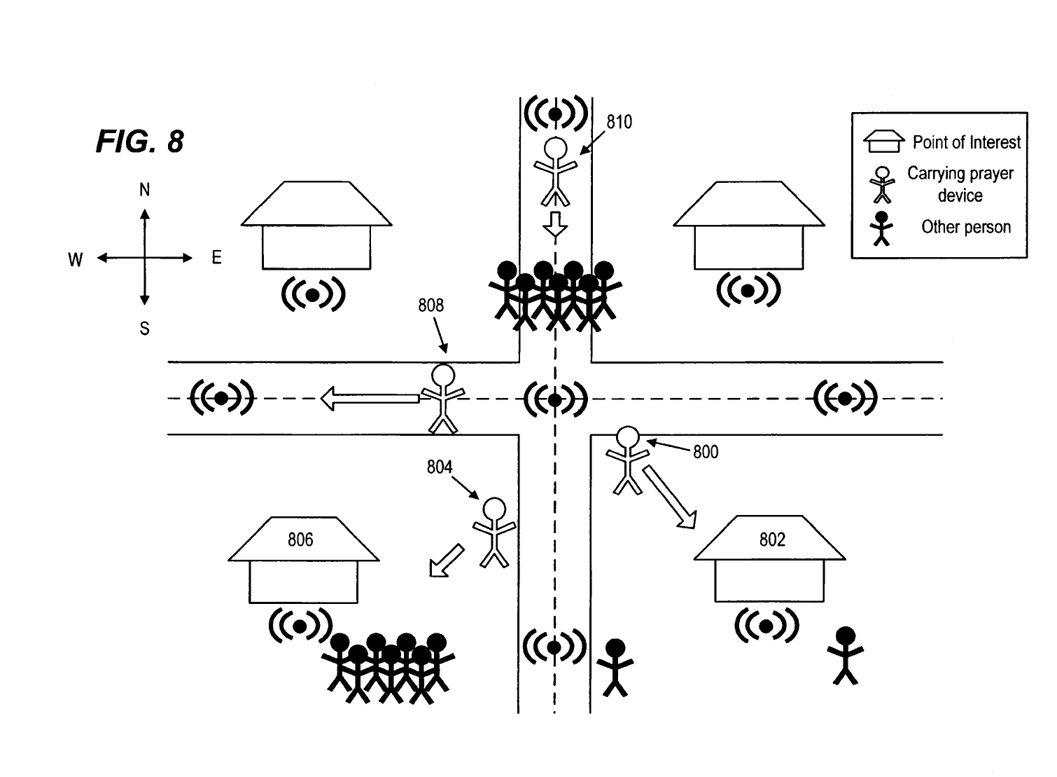

FIG. 8 is an exemplary illustration of an area congestion determination, according to certain embodiments. In one example, pilgrim 800, pilgrim 804, pilgrim 808, and pilgrim 810 possess a beaded prayer device 100 and are traveling through an area that has at least one RFID reader 202. In certain embodiments, a unique RFID tag can be associated with each beaded prayer device 100 so that the pattern extraction device 206 can determine movement patterns of a plurality of users and can determine congestion information for the area.

For example, the pattern extraction device 206 can determine a direction and velocity of travel for the pilgrims 800, 804, 808, and 810 based on the times that the beaded prayer devices that the pilgrims 800, 804, 808, and 810 possess communicate with at least one of the plurality of RFID readers 202. In the example, the pilgrim 800 is traveling toward building 802 and the pilgrim 804 is traveling toward building 806. Due to congestion in the vicinity of the building 806, the velocity of the pilgrim 804 is less than the velocity of the pilgrim 800. Based on the direction of travel and the velocity of the pilgrims 800 and 804, the pattern extraction device 206 can determine that the area around building 806 is more congested than the area around building 802.

In the example, the pilgrims 808 and 810 are traveling on roads that intersect. The pilgrim 808 is traveling west on a road away from an intersection, and the pilgrim 810 is traveling south on the road toward the intersection. The velocity of the pilgrim 810 is less than the velocity of the pilgrim 808 due to the congestion near the intersection of the roads. Based on the direction of travel and velocity of pilgrims 810 and 808, the pattern extraction device can determine that the road west of the intersection is less congested than the road near the intersection. In another embodiment, a receiver for a positioning system, such as GPS, can be installed in the end section 108 of the beaded prayer device 100 that can be used to determine the velocity and direction of travel for the pilgrims 800, 804, 808, and 810.

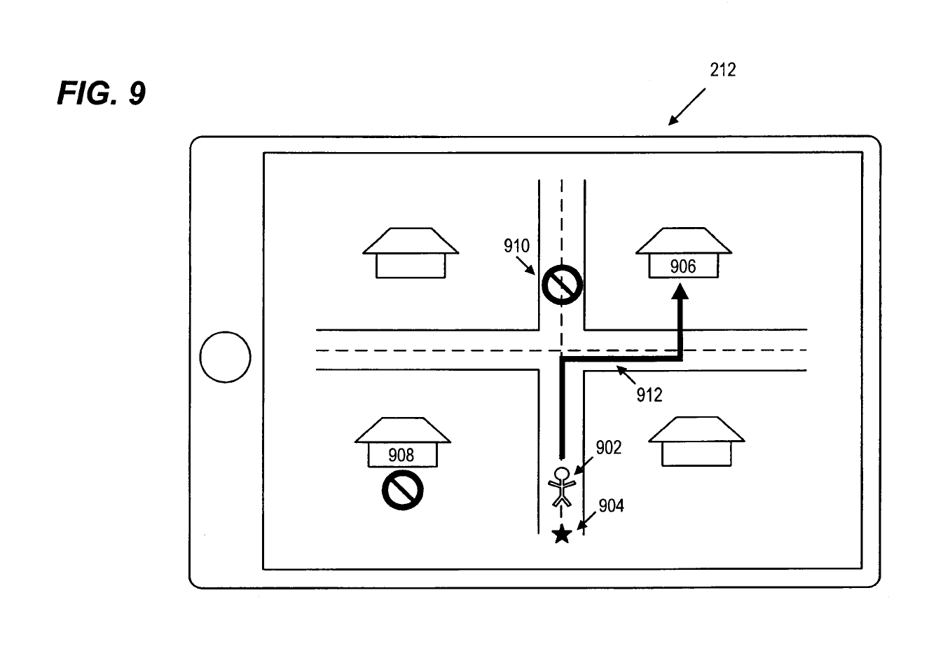

FIG. 9 is an exemplary illustration of a path determination, according to certain embodiments. In one example, a pilgrim 902 is traveling from starting point 904 to building 906. Based on the congestion information for the area determined by the pattern extraction device 206, the processing circuitry in the pattern extraction device 206 can also determine a suggested route for the pilgrim 902 to follow. The suggested route can be determined based on factors such as shortest distance to destination and avoidance of congested areas. In the example, the area around building 908 and location 910 are congested. The pattern extraction device 206 determines that path 912 is the suggested path that the pilgrim 902 can take to reach the building 906. In some embodiments, a plurality of suggested paths can be determined, and the pilgrim 902 can select a desired path. In addition, the suggested paths can include an estimated amount of time to reach a destination. In some embodiments, the pilgrim 902 can receive information regarding the at least one suggested route via the mobile device 212.

According to certain embodiments, the beaded prayer device 100 allows a backend system to determine usage patterns regarding the prayers conducted by a user as well as the movement patterns of the user. For example, by detecting instances of bead contact between two or more adjacent beads 102 of the beaded prayer device 100, the pattern extraction device can determine how many times a prayer activity, such as tasbih, has been performed by the user. In addition, based on the communication of the RFID transmitter 114 on the beaded prayer device with one or more RFID readers 202, a route that the user has taken can be determined, such as the number of rounds in the Tawaf of the Kaaba that the user has conducted. The movement patterns of the user can also be used to determine congestion points in a specific location based on the direction and velocity of travel of the user. The pattern extraction device 206 can also determine suggested routes for the user to travel based on the congestion points.

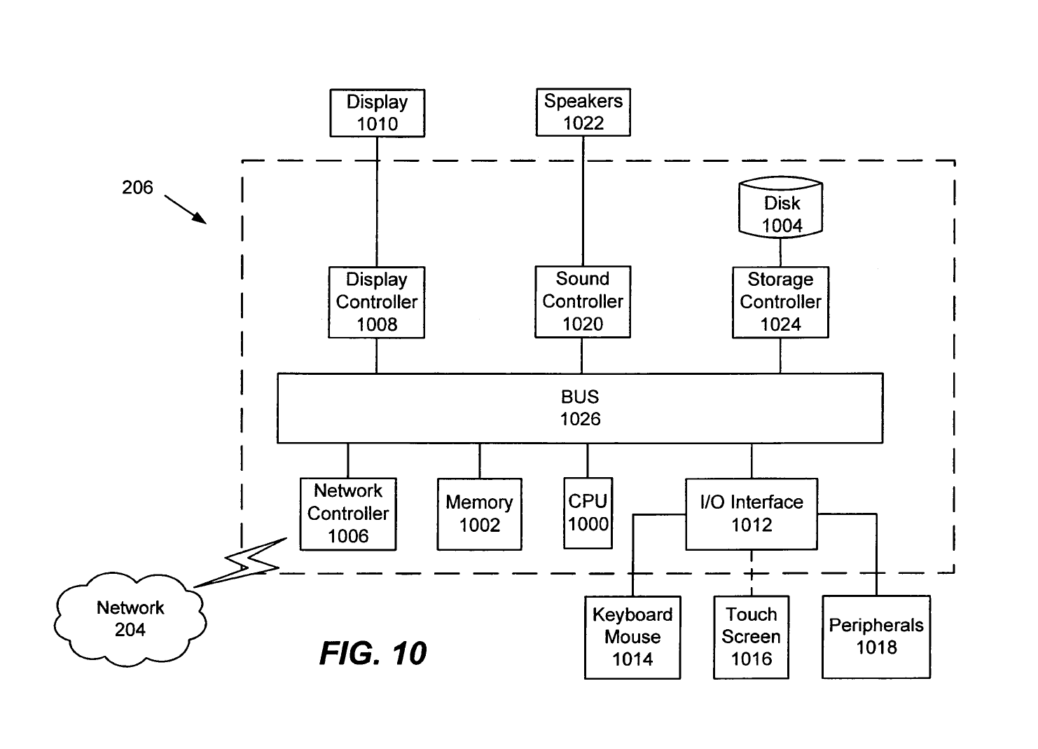

A hardware description of the pattern extraction device 206 according to exemplary embodiments is described with reference to FIG. 10. The pattern extraction device 206 includes a CPU 1000 that performs the processes described herein. The process data and instructions may be stored in memory 1002. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the pattern extraction device 206 communicates, such as a server or computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

CPU 1000 may be a Xenon or Core processor from Intel of America or an Opteron processor from AMD of America, or may be other processor types that would be recognized by one of ordinary skill in the art. Alternatively, the CPU 1000 may be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

The pattern extraction device 206 in FIG. 10 also includes a network controller 1006, such as an Intel Ethernet PRO network interface card from Intel Corporation of America, for interfacing with network 204. As can be appreciated, the network 204 can be a public network, such as the Internet, or a private network such as an LAN or WAN network, or any combination thereof and can also include PSTN or ISDN sub-networks. The network 204 can also be wired, such as an Ethernet network, or can be wireless such as a cellular network including EDGE, 3G and 4G wireless cellular systems. The wireless network can also be WI-FI, BLUETOOTH, or any other wireless form of communication that is known.

The pattern extraction device 206 further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface 1012 also connects to a variety of peripherals 1018 including printers and scanners, such as an OfficeJet or DeskJet from Hewlett Packard.

A sound controller 1020 is also provided in the pattern extraction device 206, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the pattern extraction device 206. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

In other alternate embodiments, processing features according to the present disclosure may be implemented and commercialized as hardware, a software solution, or a combination thereof. In another exemplary hardware embodiment, a keyboard manufacturer could build new and secure keyboards that accept a smartcard that includes a security profile with one or more private keys, and circuitry in the keyboard could be configured to perform a secure text generation process in accordance with the present disclosure. Moreover, instructions corresponding to a secure text generation process in accordance with the present disclosure could be stored in a thumb drive that hosts a secure process for generating the secure text on the fly. Further, aspects of the present disclosure may be implemented as a trusted operating system process or typing mode.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

The above disclosure also encompasses the embodiments listed below.

(1) A beaded prayer system, including: a beaded prayer device, having a plurality of beads connected by at least one wire passing through the plurality of beads, a power source, and processing circuitry configured to: detect contact between two or more adjacent beads, store bead contact data of the adjacent beads in memory, and transmit the bead contact data to one of a plurality of readers; and at least one server configured to: receive the bead contact data from one of the plurality of readers, process the bead contact data to perform pattern extraction, and output usage patterns and/or statistics based on the pattern extraction.

(2) The beaded prayer system of (1), wherein at least one bead includes a kinetic-to-electric energy converter that converts motion of the plurality of beads into electric energy.

(3) The beaded prayer system of (1) or (2), wherein at least one bead is made of a piezoelectric material that generates an electric potential based on the motion of the plurality of beads.

(4) The beaded prayer system of any one of (1) to (3), wherein the at least one wire transfers the electric energy to the power source.

(5) The beaded prayer system of any one of (1) to (4), wherein the processing circuitry includes at least one sensor to detect the contact between the two or more adjacent beads.

(6) The beaded prayer system of any one of (1) to (5), wherein the at least one sensor is connected to at least one of the plurality of beads.

(7) The beaded prayer system of any one of (1) to (6), wherein the processing circuitry is further configured to determine if the contact is greater than a predetermined threshold based on data obtained from the at least one sensor.

(8) The beaded prayer system of any one of (1) to (7), wherein the processing circuitry is further configured to discard the bead contact data when the processing circuitry determines that the contact is less than or equal to the predetermined threshold.

(9) The beaded prayer system of any one of (1) to (8), wherein the processing circuitry is further configured to clear the bead contact data from the memory following the processing circuitry transmitting the bead contact data to one of the plurality of RFID readers.

(10) The beaded prayer system of any one of (1) to (9), wherein the processing circuitry is further configured to clear an oldest item of the bead contact data from the memory if the memory is full.

(11) The beaded prayer system of any one of (1) to (10), wherein the at least one server is further configured to determine a number of prayers performed as a function of the bead contact data.

(12) The beaded prayer system of any one of (1) to (11), wherein the at least one server is further configured to determine a first route that a user has accomplished.

(13) The beaded prayer system of any one of (1) to (12), wherein the at least one server is further configured to determine the first route based on one or more locations of the plurality of readers with which the beaded prayer device has communicated.

(14) The beaded prayer system of any one of (1) to (13), wherein the at least one server is further configured to determine congestion of an area within range of the plurality of readers.

(15) The beaded prayer system of any one of (1) to (14), wherein the at least one server is further configured to determine the congestion of the area based on a direction of travel and a velocity the beaded prayer device.

(16) The beaded prayer system of any one of (1) to (15), wherein the at least one server is further configured to determine a suggested route based on the congestion of the area.

(17) The beaded prayer system of any one of (1) to (16), wherein the at least one server is further configured to output the usage patterns and/or statistics to a mobile device.

(18) A beaded prayer system of any one of (1) to (17), wherein one or more of the plurality of readers are RFID readers.

(19) A method of tracking prayer, including: detecting, in a beaded prayer device having a plurality of beads connected by at least one wire, contact between two or more adjacent beads; storing bead contact data in memory; transmitting, via processing circuitry, the bead contact data to one of a plurality of readers; receiving, at a server, the bead contact data from one of the plurality of readers; processing, at the server, the bead contact data to perform pattern extraction; and outputting, at the server, usage patterns and/or statistics based on the pattern extraction.

(20) A beaded prayer device, including: a plurality of beads connected by at least one wire passing through the plurality of beads; a power source; and processing circuitry configured to: detect contact between two or more adjacent beads, store bead contact data in memory, and transmit the bead contact data to one of a plurality of readers.

1. A beaded prayer system, comprising:
a beaded prayer device, having
a plurality of beads connected by at least one wire passing through the plurality of beads,
a power source, and
processing circuitry configured to:
detect contact between two or more adjacent beads,
store bead contact data of the adjacent beads in memory, and
transmit the bead contact data to one of a plurality of readers; and
at least one server configured to:
receive the bead contact data from one of the plurality of readers, process the bead contact data to perform pattern extraction, and
output usage patterns and/or statistics based on the pattern extraction.

2. The beaded prayer system of claim 1, wherein at least one bead includes a kinetic-to-electric energy converter that converts motion of the plurality of beads into electric energy.

3. The beaded prayer system of claim 2, wherein at least one bead is made of a piezoelectric material that generates an electric potential based on the motion of the plurality of beads.

4. The beaded prayer system of claim 3, wherein the at least one wire transfers the electric energy to the power source.

5. The beaded prayer system of claim 1, wherein the processing circuitry includes at least one sensor to detect the contact between the two or more adjacent beads.

6. The beaded prayer system of claim 5, wherein the at least one sensor is connected to at least one of the plurality of beads.

7. The beaded prayer system of claim 6, wherein the processing circuitry is further configured to determine if the contact is greater than a predetermined threshold based on data obtained from the at least one sensor.

8. The beaded prayer system of claim 7, wherein the processing circuitry is further configured to discard the bead contact data when the processing circuitry determines that the contact is less than or equal to the predetermined threshold.

9. The beaded prayer system of claim 1, wherein the processing circuitry is further configured to clear the bead contact data from the memory following the processing circuitry transmitting the bead contact data to one of the plurality of RFID readers.

10. The beaded prayer system of claim 9, wherein the processing circuitry is further configured to clear an oldest item of the bead contact data from the memory if the memory is full.

11. The beaded prayer system of claim 1, wherein the at least one server is further configured to determine a number of prayers performed as a function of the bead contact data.

12. The beaded prayer system of claim 11, wherein the at least one server is further configured to determine a first route that a user has accomplished.

13. The beaded prayer system of claim 12, wherein the at least one server is further configured to determine the first route based on one or more locations of the plurality of readers with which the beaded prayer device has communicated.

14. The beaded prayer system of claim 13, wherein the at least one server is further configured to determine congestion of an area within range of the plurality of readers.

15. The beaded prayer system of claim 14, wherein the at least one server is further configured to determine the congestion of the area based on a direction of travel and a velocity the beaded prayer device.

16. The beaded prayer system of claim 15, wherein the at least one server is further configured to determine a suggested route based on the congestion of the area.

17. The beaded prayer system of claim 1, wherein the at least one server is further configured to output the usage patterns and/or statistics to a mobile device.

18. A beaded prayer system of claim 1, wherein one or more of the plurality of readers are RFID readers.

19. A method of tracking prayer, comprising:
detecting, in a beaded prayer device having a plurality of beads connected by at least one wire, contact between two or more adjacent beads;
storing bead contact data in memory;
transmitting, via processing circuitry, the bead contact data to one of a plurality of readers;
receiving, at a server, the bead contact data from one of the plurality of readers;
processing, at the server, the bead contact data to perform pattern extraction; and
outputting, at the server, usage patterns and/or statistics based on the pattern extraction.

20. A beaded prayer device, comprising:
a plurality of beads connected by at least one wire passing through the plurality of beads;
a power source; and
processing circuitry configured to:
detect contact between two or more adjacent beads,
store bead contact data in memory, and
transmit the bead contact data to one of a plurality of readers.
